(19) United States
(12) Patent Application Publication
(10) Pub. No.: US 2019/0152386 A1
(43) Pub. Date: May 23, 2019

(54) METHODS AND APPARATUS TO FACILITATE SUGGESTION OF UNDER-UTILIZED FEATURES

(71) Applicant: Ford Global Technologies, LLC, Dearborn, MI (US)

(72) Inventors: Michael McQuillen, Warren, MI (US); Ross Dykstra Pursifull, Dearborn, MI (US); Daniel A. Makled, Dearborn, MI (US); Gopichandra Surnilla, West Bloomfield, MI (US)

(21) Appl. No.: 15/816,727

(22) Filed: Nov. 17, 2017

(51) Int. Cl. B60Q 9/00

(52) U.S. Cl. CPC B60Q 9/00

(57) ABSTRACT

Methods and apparatus are disclosed for suggestion of under-utilized features. A vehicle comprises sensors, a processor, and a display interface. The processor is in communication with the sensors and is to: receive inputs from the sensors, select one of multiple driving situations using the inputs, select a convenience feature corresponding to the selected driving situation, determine usage of the convenience feature using the inputs, and generate a message regarding use of the convenience feature. The display interface is in communication with the processor and is to display the message.

### TECHNICAL FIELD

The present disclosure generally relates to vehicle convenience features and, more specifically, methods and apparatus to facilitate suggestion of under-utilized features.

### BACKGROUND

In recent years, vehicles have been equipped with vehicle convenience features such as automatic parallel parking, automatic seat adjustments, lane detection, cruise control, and adaptive cruise control, among others. Vehicle convenience features often facilitate operation of vehicles and/or make vehicles more enjoyable to drive. Vehicle convenience features are often engaged by a driver via an interface of a vehicle.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

An example vehicle is disclosed. The vehicle comprises sensors, a processor, and a display interface. The processor is in communication with the sensors and is to: receive inputs from the sensors, select one of multiple driving situations using the inputs, select a convenience feature corresponding to the selected driving situation, determine usage of the convenience feature using the inputs, and generate a message regarding use of the convenience feature. The display interface is in communication with the processor and is to display the message.

An example method is disclosed. The method comprises: receiving, with a processor of a vehicle, inputs from sensors; selecting, with the processor, one of multiple driving situations using the inputs; selecting, with the processor, a convenience feature corresponding to the selected driving situation; determining, with the processor, usage of the convenience feature using the inputs; generating, with the processor, a message regarding use of the convenience feature; and displaying the message via a display interface of the vehicle.

A vehicle convenience feature reminder system is disclosed. The system comprises: sensors, a processor, and a display interface. The processor is in communication with the sensors and is to: recognize when a convenience feature is underutilized during a corresponding driving situation based on input from the sensors and generate a message reminding a driver of the convenience feature. The display interface is in communication with the processor and is to display the message.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 is a cross sectional view of a vehicle operating in accordance with the teachings of this disclosure.

FIG. 2 is an internal cabin view of the vehicle of FIG. 1.

FIG. 3 is a block diagram of electronic components of the vehicle of FIG. 1.

FIG. 4 is a more detailed block diagram of the feature suggester of FIG. 3.

FIG. 5 is a table of inputs, driving situations, and vehicle convenience features stored in the memory of FIG. 3.

FIG. 6 is a flowchart of a method to suggest use of under-utilized features, which may be implemented by the electronic components of FIG. 3.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

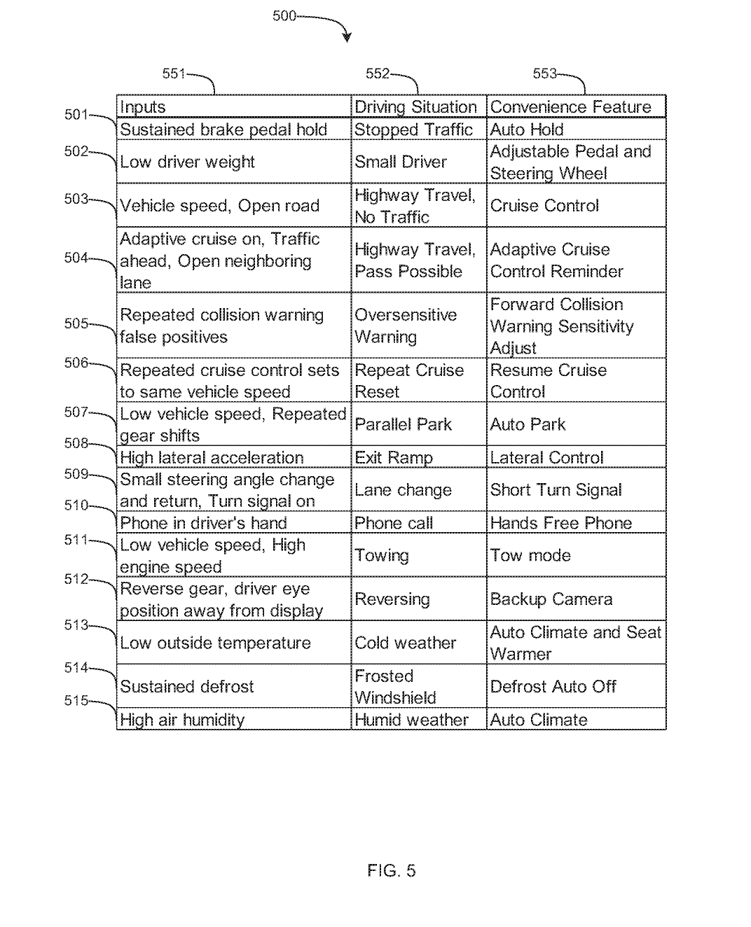

Vehicle convenience features, such as cruise control, improve comfort and facilitate operation of a vehicle. Additional vehicle convenience features include, for example, automatic brake pedal hold, adjustable brake pedals, adjustable steering wheels, adaptive cruise control, forward collision warning, cruise control resume, automatic parallel parking, and automatic lateral control, among others. Traditionally, with vehicle convenience features, the user is required engage the vehicle convenience feature (e.g., pressing a button to engage automatic parallel parking) during a particular driving situation (e.g., while looking for a parking spot). In other words, the user needs to know which features are available and when particular features should be used. As used herein, the term “driving situation” refers to a lay driver's understanding of vehicle dynamics, vehicle settings, and the environment in and around a vehicle at a particular point in time. In other words, a “driving situation” encompasses, who, how, and where a vehicle operates at a given time. Examples of driving situations include highway travel, waiting at a stoplight or railroad crossing, hot weather, a small-statured driver, etc. Further examples of driving situations will be explained in greater detail in conjunction with FIG. 5.

As disclosed below, a method of and an apparatus for suggesting under-utilized vehicle convenience features is provided to recognize driving situations and to remind a user of vehicle convenience features that may be helpful during those driving situations. In other words, the apparatus executes the method to recognize when an available vehicle convenience feature could be used by a driver, but is not, and to suggest use of the available but unused vehicle convenience feature to the driver. A vehicle includes an on-board computing platform, sensors, a display interface. The sensors collect data related to the dynamics of the vehicle (e.g., vehicle speed, wheel speed, steering angle, wheel angle, gear selection, acceleration, etc.). To suggest use of a vehicle platform, the on-board computing platform determines a driving situation based on the data collected by the sensors, determines vehicle convenience features applicable to that driving situation, and determines whether the vehicle convenience feature is under-utilized. In some examples, the on-board computing platform determines whether use of the feature would be beneficial to vehicle operation (e.g., a driver is not using cruise control but is maintaining a steady vehicle speed). If the vehicle convenience feature is under-utilized (and beneficial), the on-board computing platform 170 displays a message related to the vehicle convenience feature to the user via the display interface.

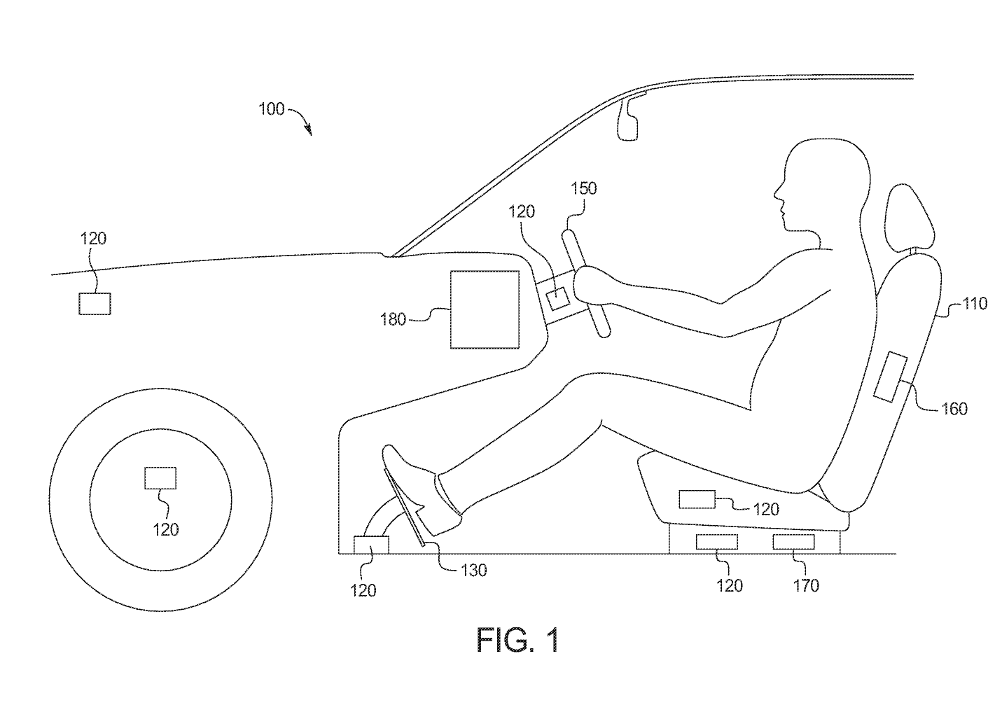

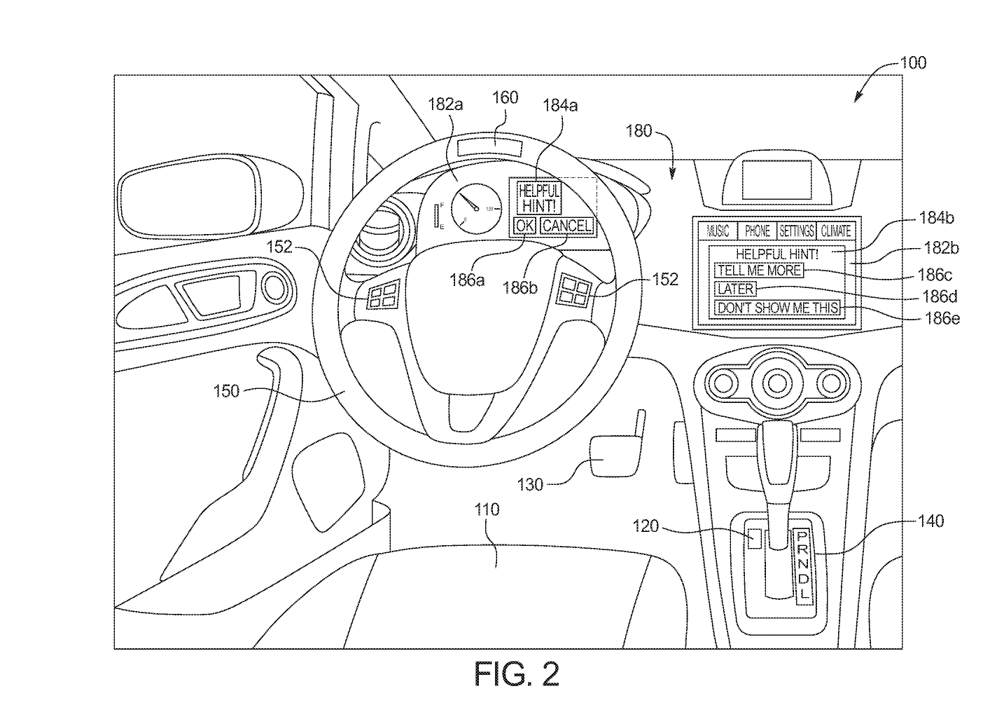

FIG. 1 is a cross sectional view of a vehicle 100 operating in accordance with the teachings of this disclosure. FIG. 2 is an internal cabin view of the vehicle 100 of FIG. 1. As shown in FIGS. 1 and 2, the vehicle 100 includes a seat 110, a plurality of sensors 120, a brake pedal 130, a gearshift 140, a steering wheel 150, a plurality of haptic devices 160, an on-board computing platform 170, and an infotainment head unit 180.

The sensors 120 may be arranged in and around the vehicle 100 in any suitable fashion. The sensors 120 may be mounted to measure properties around the exterior of the vehicle 100. Additionally, some sensors 120 may be mounted inside the cabin of the vehicle 100 or in the body of the vehicle 100 (such as, the engine compartment, the wheel wells, etc.) to measure properties in the interior of the vehicle 100. For example, such sensors 120 may include accelerometers, odometers, tachometers, pitch and yaw sensors, wheel speed sensors, microphones, tire pressure sensors, and biometric sensors, etc. In the illustrated example, the sensors 120 include a weight sensor, a steering angle sensor, a pedal sensor, one or more wheel speed sensors, an inertial measurement unit, a forward collision sensor and a gearshift selection sensor. The weight sensor senses a weight of a driver seated in the seat 110. The steering angle sensor senses a steering angle of the steering wheel 150. The pedal sensor senses actuation of the brake pedal 130. The one or more wheel speed sensors sense rotational speed of the wheels of the vehicle 100. The inertial measurement unit senses acceleration and rotation of the vehicle 100. The gearshift selection sensor senses a gear selection of the gearshift 140. The forward collision sensor senses other vehicles in front of the vehicle 100.

The haptic devices 160 may be electronic buzzers, shakers, and/or tappers. The haptic devices 160 provide tactile feedback to a driver. In the illustrated example, a haptic device 160 is built into the seat 110 to provide tactile feedback to a driver's back. In the illustrated example, a haptic device 160 is housed in the steering wheel 150 to provide tactile feedback to a driver's hands. It should be understood that the vehicle 100 may include fewer or additional haptic devices 160 than those shown in FIGS. 1 and 2.

In the illustrated example, the steering wheel 150 includes a plurality of instrument cluster controls 152. In the illustrated example, the instrument cluster controls 152 are a left thumb pad and a right thumb pad. In operation, a user may control convenience and/or information features of the vehicle 100 via the instrument cluster controls 152.

The infotainment head unit 180 provides an interface between the vehicle 100 and a user. The infotainment head unit 180 includes digital and/or analog interfaces (e.g., input devices and output devices) to receive input from the user(s) and display information. The input devices may include, for example, a control knob, an instrument panel, a digital camera for image capture and/or visual command recognition, a touch screen, an audio input device (e.g., cabin microphone), buttons, or a touchpad. The output devices may include instrument cluster outputs (e.g., dials, lighting devices), actuators, a heads-up display, a center console display (e.g., a liquid crystal display (“LCD”), an organic light emitting diode (“OLED”) display, a flat panel display, a solid state display, etc.), and/or speakers. In the illustrated example, the infotainment head unit 180 includes hardware (e.g., a processor or controller, memory, storage, etc.) and software (e.g., an operating system, etc.) for an infotainment system (such as SYNC® and MyFord Touch® by Ford®, Entune® by Toyota®, IntelliLink® by GMC®, etc.). Additionally, the infotainment head unit 180 displays the infotainment system on, for example, the center console display.

In the illustrated example, the infotainment head unit 180 includes an instrument cluster display interface 182a and a console display interface 182b. The infotainment head unit 180 displays messages related to under-utilized vehicle convenience features. The messages may be suggestion messages to use an under-utilized vehicle convenience feature and/or congratulatory messages to the driver on efficient driving despite under-utilization of the vehicle convenience feature. The messages may include option buttons to learn about the under-utilized feature immediately or at a later time or to dismiss the message. The option buttons are executed via the instrument cluster controls 152 and/or the console display interface 182b. In the illustrated example, the instrument cluster display interface 182a displays a first message 184a and the console display interface 182b displays a second message 184b. The first and second messages 184a, 184b may be related to the same under-utilized feature. The first message 184a includes a first option button 186a “OK” to learn more about a detected under-utilized feature and a second option button 186b “Cancel” to dismiss at least one of the first and second messages 184a, 184b from the display interfaces 182a, 182b. The second message 184b includes a third option button 186c “Tell me more” to learn more about the detected under-utilized feature immediately via the display interfaces 182a, 182b, a fourth option button 186d “Later” to learn about the under-utilized feature at a later time, and a fifth option button 186e “Don't show me this again” to dismiss the messages 182 from the display interfaces 182a, 182b.

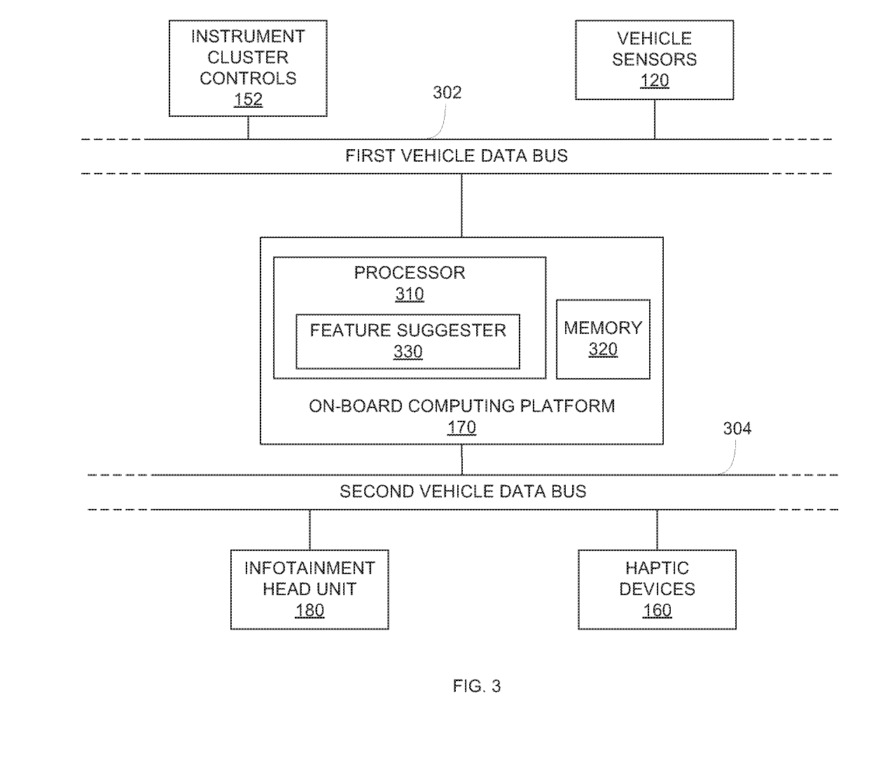

FIG. 3 is a block diagram of electronic components 300 of the vehicle 100 of FIG. 1. In the illustrated example, the electronic components 300 include the sensors 120, the instrument cluster controls 152, on-board computing platform 170, the haptic devices 160, and the infotainment head unit 180, a first vehicle data bus 302, and a second vehicle data bus 304.

The first vehicle data bus 302 communicatively couples the sensors 120, the instrument cluster controls 152, the on-board computing platform 170, and other devices connected to the first vehicle data bus 302. In some examples, the first vehicle data bus 302 is implemented in accordance with the controller area network (CAN) bus protocol as defined by International Standards Organization (ISO) 11898-1. Alternatively, in some examples, the first vehicle data bus 302 may be a Media Oriented Systems Transport (MOST) bus, or a CAN flexible data (CAN-FD) bus (ISO 11898-7). The second vehicle data bus 304 communicatively couples the on-board computing platform 170, the infotainment head unit 180, and the haptic devices 160. The second vehicle data bus 304 may be a MOST bus, a CAN-FD bus, or an Ethernet bus. In some examples, the on-board computing platform 170 communicatively isolates the first vehicle data bus 302 and the second vehicle data bus 304 (e.g., via firewalls, message brokers, etc.). Alternatively, in some examples, the first vehicle data bus 302 and the second vehicle data bus 304 are the same data bus.

In the illustrated example, the on-board computing platform 170 includes a processor or controller 310 and a memory 320. The processor or controller 310 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 320 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, non-volatile solid-state memory, etc.), unalterable memory (e.g., EPROMs), read-only memory, and/or high-capacity storage devices (e.g., hard drives, solid state drives, etc). In some examples, the memory 320 includes multiple kinds of memory, particularly volatile memory and non-volatile memory.

In the illustrated example, the processor 310 includes a feature suggester 330. In operation, using the feature suggester 330, the on-board computing platform 170 detects under-utilized vehicle convenience features based on inputs from the sensors 120 and the instrument cluster controls 152 and suggests use of the features via the infotainment head unit 180 and/or the haptic devices 160.

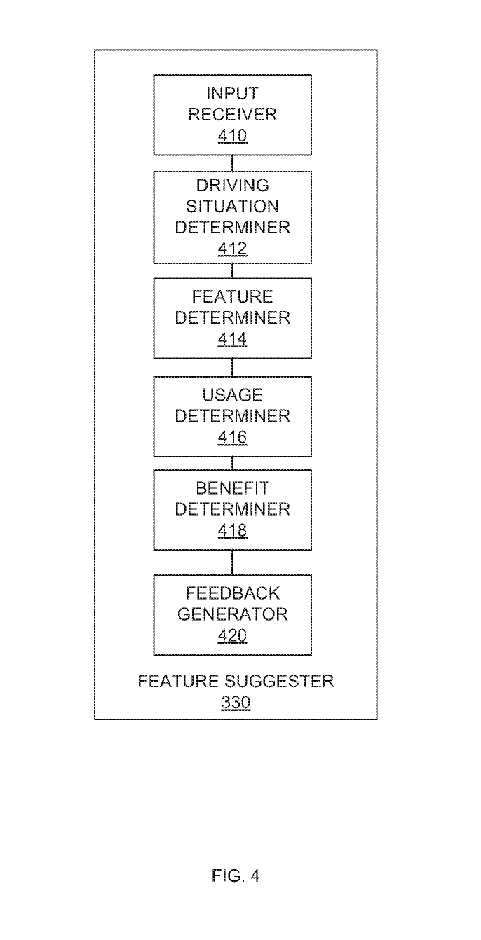

FIG. 4 is a more detailed block diagram of the feature suggester 330 of FIG. 3. In the illustrated example, the feature suggester 330 includes an input receiver 410, a driving situation determiner 412, a feature determiner 414, a usage determiner 416, a benefit determiner 418, and a feedback generator 420.

The input receiver 410 is in communication with the a driving situation determiner 412. The driving situation determiner 412 is in communication with the feature determiner 414. The feature determiner 414 is in communication with the usage determiner 416. The usage determiner 416 is in communication with the benefit determiner 418. The benefit determiner 418 is in communication with the feedback generator 420.

In operation, the input receiver 410 receives inputs from the sensors 120 (e.g., vehicle speed, vehicle yaw rate, driver weight, pedal actuation, gear selection.

In operation, the driving situation determiner 412 determines a driving situation and/or a driver intent based on the received inputs. In some examples, the driving situation determiner 412 accesses the memory 320 to match the received inputs to a set of predetermined driving situations. In other words, the driving situation determiner 412 compares the received inputs against a log of inputs and corresponding driving situations stored in the memory 320. The driving situation determiner 412 selects a driving situation that corresponds to the matching received and logged inputs from the set of predetermined driving situations.

In operation, the feature determiner 414 determines one or more vehicle convenience features based on the selected driving situation. In some examples, the feature determiner 414 accesses the memory 320 to match the selected driving situation to a set of predetermined vehicle convenience features. In other words, the feature determiner 414 compares the selected driving situation against a log of corresponding vehicle convenience features stored in the memory 320. The feature determiner 414 selects a vehicle convenience feature that corresponds to the selected driving situation from the set of corresponding vehicle convenience features.

In operation, the usage determiner 416 determines whether the selected vehicle feature is being used. More specifically, the usage determiner 416 generates a usage determination. The usage determination may be positive if the selected vehicle convenience feature is being used. The usage determination may be negative if the vehicle convenience feature is not being used. If the usage determination is positive, the feature suggester 330 continues to receive inputs via the input receiver 410.

In operation, the benefit determiner 418 receives the negative usage determination, the selected vehicle convenience feature, and the received inputs. More specifically, in response to the negative usage determination, the benefit determiner 418 generates a benefit determination by determining whether use of the selected vehicle feature would be beneficial to operation of the vehicle 100 based on the received inputs. The benefit determination may be positive or negative. In other words, the benefit determiner 418 determines whether a driver is operating the vehicle 100 more efficiently than the selected vehicle convenience feature could operate the vehicle 100. For example, where a driver is maintaining a highway speed more precisely than cruise control could maintain the speed, the benefit determination would be negative. Conversely, for example, where an auto hold convenience feature could maintain brake pressure as well or better than a driver applying sustained pressure to the brake pedal 130, the benefit determination would be positive. In some examples, if the benefit determination is negative, the feature suggester 330 continues to receive inputs via the input receiver 410.

In operation, the feedback generator 420 receives the negative usage determination, the selected vehicle convenience feature, and the benefit determination.

More specifically, in response to the negative usage determination and a positive benefit determination, the feedback generator 420 generates a suggestion message for display via at least one of the display interfaces 182a, 182b (as shown in FIGS. 1 and 2) based on the selected vehicle convenience feature. In some examples, the suggestion message includes instructions on how to use the selected vehicle convenience feature. The instructions may be displayed on one or more of the display interfaces 182a, 182b (e.g., as text, pictures, photographs, drawings, a video, etc.) and/or recited to the driver via a sound system of the vehicle 100. In some examples, the instructions are displayed and/or recited only when the vehicle 100 is stopped and/or when the gearshift 140 is placed in a park position (e.g., “P,” “PARK,” etc.).

In some examples, in response to the negative usage determination and a negative benefit determination, the feedback generator 420 generates a congratulatory message for display via at least one of the display interfaces 182a, 182b and/or provides tactile feedback to the driver via one or more of the haptic devices 160 based on the selected vehicle convenience feature. The congratulatory message may inform the driver that he or she is operating the vehicle 100 more efficiently than could be accomplished by the selected vehicle convenience feature. The congratulatory message may remind the driver of the selected vehicle convenience feature and provide an option button to review the instructions discussed above. The tactile feedback may provide sensations of a pat on the driver's back and/or a handshake to the driver's hands.

In some examples, in response to a received input that the driver used a suggested vehicle convenience feature, the feedback generator 420 generates a follow-up congratulatory message and/or tactile feedback for successful usage of the vehicle convenience feature.

In some examples, the feedback generator 420 generates suggestion messages when a selected vehicle convenience feature is habitually under-utilized. In other words, the feedback generator 420 tracks the number of negative usage determinations paired with positive benefit determinations related to particular vehicle convenience features and generates suggestion messages when the number exceeds a threshold. Thus, the feature suggester 330 suggests use of vehicle convenience features occasionally.

FIG. 5 is a table 500 of inputs, driving situations, and vehicle convenience features stored in the memory 320 of FIG. 3. In the illustrated example, the table 500 includes fifteen rows 501 to 515. In the illustrated example, the table 500 includes first, second, and third columns 551, 552, 553. In the first column 551, the rows 501 to 508 include inputs that may be sensed by the sensors 120 of FIGS. 1 and 2. In the second column 552, the rows 501 to 508 include driving situations that correspond to the inputs of the first column 551. In the third column 553, the rows 501 to 508 include vehicle convenience features that correspond to the driving situations of the second column 552.

As shown in row 501, an input of a sustained brake hold (e.g., longer than a threshold time) is indicative of a stopped traffic driving situation. The Auto Hold vehicle convenience feature to maintain brake pressure without actuating the brake pedal 130 of FIGS. 1 and 2 corresponds to and may be helpful to a driver in a stopped traffic driving situation.

As shown in row 502, an input of a low driver weight (e.g., lower than a threshold weight) is indicative of a small driver. The Adjustable Pedal and Steering Wheel vehicle convenience feature to adjust the positions of the brake pedal 130 and the steering wheel 150 corresponds to and may be helpful to a small driver. It should be appreciated that moving the brake pedal 130 closer to a driver's foot may be more comfortable for a small driver. It should be appreciated that adjusting the brake pedal 130 and the steering wheel 150 may maintain and/or produce a recommended chest-to-steering wheel distance while facilitating access to the brake pedal 130.

As shown in row 503, inputs of vehicle speed (e.g., above a threshold speed) and a detected open road are indicative of a driving situation of highway travel with no traffic. The Cruise Control vehicle convenience feature to maintain brake a vehicle speed corresponds to and may be helpful to a driver in a highway travel with no traffic driving situation. It should be appreciated that the Cruise Control vehicle convenience feature may increase comfort and improve fuel economy.

As shown in row 504, inputs that adaptive cruise control is on, detected traffic ahead, and an open neighboring lane beside the vehicle 100 are indicative of a driving situation of highway travel with a possible overtaking pass. The Adaptive Cruise Control Reminder vehicle convenience feature to remind a driver that a faster travel lane is open corresponds to and may be helpful to a driver in a driving situation where a driver is following a slow vehicle using adaptive cruise control and a passing lane to overtake the slow vehicle is open.

As shown in row 505, inputs of repeated false positives from a forward collision warning system of the vehicle 100 are indicative of a driving situation of an oversensitive forward collision warning system. The Forward Collision Warning Sensitivity Adjust vehicle convenience feature to modify the sensitivity of the forward collision warning system corresponds to and may be helpful to a driver in a driving situation where the forward collision warning system is overly sensitive.

As shown in row 506, inputs of repeated “set speed” commands to the same vehicle speed in a cruise control system of the vehicle 100 are indicative of a driving situation where the cruise control is repeatedly turned off and reset to the same speed. The Resume Cruise Control vehicle convenience feature to resume cruise control to a previous speed after the cruise control was removed corresponds to and may be helpful to a driver in a driving situation where the cruise control is repeated engaged and disengaged.

As shown in row 507, inputs of low vehicle speed and repeated gear shifts are indicative of a driving situation of parallel parking. The Auto Park vehicle convenience feature to automatically parallel park the vehicle 100 corresponds to and may be helpful to a driver in a parallel parking driving situation.

As shown in row 508, an input of high lateral acceleration (e.g., above a threshold) is indicative of an exit ramp driving situation. The Lateral Control vehicle convenience feature to automatically slow the vehicle 100 in a tight turn corresponds to and may be helpful to a driver in an exit ramp or similar driving situation.

As shown in row 509, inputs of small steering angle changes and returns and an illuminated turn signal are indicative of a lane change driving situation. The Short Duration Turn Signal vehicle convenience feature to illuminate the turn signal briefly corresponds to and may be helpful to a driver in a lane change driving situation.

As shown in row 510, an input of a telephone in a driver's hand (e.g., via an internal camera of the vehicle 100) is indicative of an Phone Call driving situation. The Hands Free Phone vehicle convenience feature to enable hands free telephone use through the infotainment system corresponds to and may be helpful to a driver in a telephone call driving situation.

As shown in row 511, inputs of low vehicle speed and high engine load (e.g., exceeding a threshold ratio) are indicative of a towing driving situation. The Tow Mode vehicle convenience feature to automatically modify transmission shift points corresponds to and may be helpful to a driver in a towing driving situation.

As shown in row 512, inputs that the gearshift 140 is in reverse and that the driver's eyes are looking away from the display interfaces 182a, 182b are indicative of a reversing driving situation. The Backup Camera vehicle convenience feature to display what is behind the vehicle 100 via one or more of the display interfaces 182a, 182b corresponds to and may be helpful to a driver in reversing driving situation.

As shown in row 513, an input of low outside air temperature (e.g., below a threshold) is indicative of a cold weather driving situation. The Auto Climate and Seat Warmer vehicle convenience features to automatically adjust a climate control system and seat warmers of the vehicle 100 corresponds to and may be helpful to a driver in a cold weather driving situation.

As shown in row 514, an input of sustained use of a defroster of the vehicle 100 (e.g., longer than a threshold) is indicative of frosted windshield driving situation. The Defrost Auto Off vehicle convenience feature to automatically turn off the defroster after a set time corresponds to and may be helpful to a driver in a frosted windshield driving situation. It should be appreciate that the Defrost Auto Off vehicle convenience feature may prevent hot, dry air from blowing into a driver's face for a prolonged period, thus improving driver comfort.

As shown in row 515, an input of high air humidity (e.g., above a threshold) is indicative of humid weather driving situation. The Auto Climate vehicle convenience feature to automatically turn on the climate control system corresponds to and may be helpful to a driver in a humid weather driving situation.

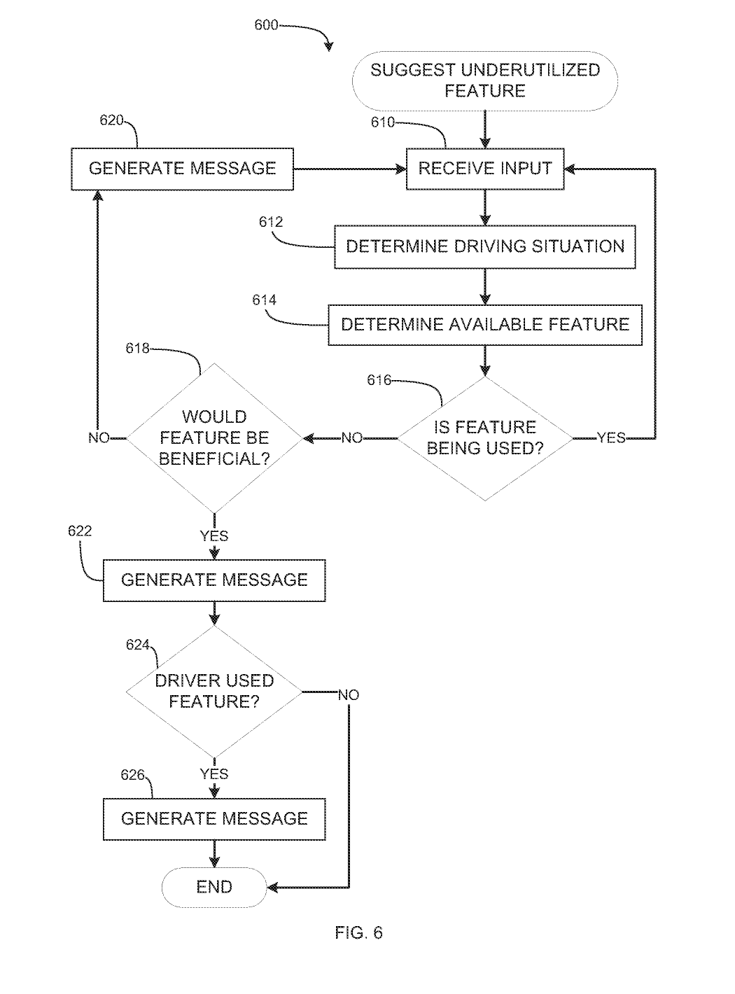

The flowchart of FIG. 6 is representative of machine readable instructions stored in memory (such as the memory 320 of FIG. 3) that comprise one or more programs that, when executed by a processor (such as the processor 310 of FIG. 3), cause the vehicle 100 to implement the example feature suggester 330 of FIG. 3. Further, although the example program(s) is/are described with reference to the flowchart illustrated in FIG. 6, many other methods of implementing the example feature suggester 330 may alternatively be used. For example, the order of execution of the blocks may be changed, and/or some of the blocks described may be changed, eliminated, or combined. Further, because the method 600 is disclosed in connection with the components of FIGS. 3-4, some functions of those components will not be described in detail below.

FIG. 6 is a flowchart of a method 600 to suggest use of under-utilized features, which may be implemented by the electronic components 300 of FIG. 3. Initially, at block 610, the input receiver 410 receives input from the sensors 120.

At block 612, the driving situation determiner 412 determines a driving situation based on the received inputs.

At block 614, the feature determiner 414 determines available vehicle convenience features based on the determined driving situation.

At block 616, the usage determiner 416 determines whether the available vehicle convenience features are being used.

If, at block 616, the usage determiner 416 determines that the available vehicle convenience features are being used, the method 600 returns to block 610.

If, at block 616, the usage determiner 416 determines that the available vehicle convenience features are not being used, the method 600 proceeds to block 618.

At block 618, the benefit determiner 418 determines whether use of the determined available vehicle convenience features would be beneficial to operation of the vehicle 100.

If, at block 618, the benefit determiner 418 determines that used of the determined available vehicle convenience features would not be beneficial to operation of the vehicle 100, the method 600 proceeds to block 620.

At block 620, the feedback generator 420 generates a congratulatory message for the driver for operating the vehicle 100 efficiently. The method then returns to block 610.

If, at block 618, the benefit determiner 418 determines that used of the determined available vehicle convenience features would be beneficial to operation of the vehicle 100, the method 600 proceeds to block 622

At block 622, the feedback generator 420 generates a suggestion message for the driver to suggest use of the available determined vehicle convenience features.

At block 624, usage determiner 416 determines whether the suggested vehicle convenience feature was used by the driver.

If, at block 624, the usage determiner 416 determines that the suggested vehicle convenience feature was used by the driver, the method 600 proceeds to block 626.

At block 626, the feedback generator 420 generates a congratulatory message and/or tactile feedback for the driver for using the suggested vehicle convenience feature.

If, at block 624, the usage determiner 416 determines that the suggested vehicle convenience feature was not used by the driver, the method 600 ends.

From the foregoing, it should be appreciated that the above disclosed apparatus and methods may aid drivers in operating vehicles by reminding drivers of available automated vehicle convenience features during particular driving situations. Further, once prompted to use the vehicle convenience features, drivers may operate vehicles more efficiently. It should also be appreciated that the disclosed apparatus and methods provide a specific solution—prompting drivers to use available vehicle convenience features in the context of a particular driving situation—to a specific problem—drivers who forget or are unaware of when or how to use available vehicle convenience features. Further, the disclosed apparatus and methods provide an improvement to computer-related technology by increasing functionality of a processor to recognize multiple driving situations, select a vehicle convenience feature applicable to a particular driving situation, determine whether use of the selected vehicle convenience feature would improve vehicle operation efficiency, and generate messages regarding use of the vehicle convenience feature.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

As used here, the terms “module” and “unit” refer to hardware with circuitry to provide communication, control and/or monitoring capabilities, often in conjunction with sensors. “Modules” and “units” may also include firmware that executes on the circuitry.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

1. A vehicle comprising:
sensors;
a haptic device; and
processors configured to:
measure, via the sensors, performance at which a driver operates the vehicle under a current driving situation;
compare the performance to a convenience feature corresponding to the current driving situation; and
responsive to the performance outperforming the convenience feature, provide, via the haptic device, a tactile feedback.

2. The vehicle of claim 1, wherein the processors are further configured to:
receives inputs from the sensors; and
determine whether use of the convenience feature would improve vehicle operation efficiency using the inputs.

3. The vehicle of claim 2, wherein, if use of the convenience feature would improve vehicle operation efficiency, the message suggests use of the convenience feature.

4. The vehicle of claim 3, wherein the processors are further configured to determine whether the suggested convenience feature was used based on the inputs.

5. A vehicle comprising:
sensors;
a processor in communication with the sensors to:
receive inputs from the sensors;
select one of multiple driving situations using the inputs;
select a convenience feature corresponding to the selected driving situation;
determine usage of the convenience feature using the inputs; and
generate a message regarding use of the convenience feature; and
a display interface in communication with the processor to display the message,
wherein the driving situations include stopped traffic, a small driver, highway travel without traffic, highway travel with an open neighboring lane, an oversensitive warning system, repeated cruise control resets, parallel parking, an exit ramp, a lane change, a telephone call while driving, towing, reversing, cold weather, a frosted windshield, and humid weather.

6. The vehicle of claim 1, wherein the sensors include two or more of a weight sensor, a steering angle sensor, a pedal sensor, a wheel speed sensor, an inertial measurement unit, a forward collision sensor, or a gearshift selection sensor.

7. (canceled)

8. The vehicle of claim 1, further comprising a display interface, the display interface configured to display a message regarding use of the convenience feature; and display instructions regarding the convenience feature, the instructions being accessible via an option button included in the message.

9. A method comprising:
measuring, via sensors of a vehicle, performance at which a driver operates the vehicle under a current driving situation;
comparing, via processors of the vehicle, the performance to a convenience feature corresponding to the current driving situation; and
responsive to the performance outperforming the convenience feature, providing, via a haptic device, a tactile feedback.

10. The method of claim 9, further comprising receiving, at the processors, inputs from the sensors; and determining, via the processors, whether use of the convenience feature would improve vehicle operation efficiency using the inputs.

11. The method of claim 10, wherein, if use of the convenience feature would improve vehicle operation efficiency, the message suggests use of the convenience feature.

12. The method of claim 11, further comprising determining, with the processors, whether the suggested convenience feature was used using the inputs.

13. (canceled)

14. The method of claim 9, wherein the sensors include two or more of a weight sensor, a steering angle sensor, a pedal sensor, a wheel speed sensor, an inertial measurement unit, a forward collision sensor, or a gearshift selection sensor.

15. (canceled)

16. A vehicle convenience feature reminder system comprising:
sensors;
a haptic device; and
processors configured to:
measure, via the sensors, performance at which a driver operates the vehicle under a current driving situation;
compare the performance to a convenience feature corresponding to the current driving situation; and
responsive to the performance outperforming the convenience feature, provide, via the haptic device, a tactile feedback.

17. The system of claim 16, further comprising a display device, wherein the processors are further configured to provide instructions regarding use of the convenience feature via the display interface.

18. (canceled)

19. The system of claim 18, further comprising a seat comprising a back support, wherein the tactile feedback is disposed in the back support.

20. The system of claim 16, wherein the processors are further configured to determine whether use of the convenience feature would improve vehicle operation efficiency.

21. The vehicle of claim 1, further comprising a steering wheel, wherein the haptic device is disposed in the steering wheel.

22. The vehicle of claim 1, further comprising a display interface, wherein the processors are further configured to: determine a number of uses of the convenience feature; and
responsive to the number of uses being less than a threshold and responsive to the performance outperforming the convenience feature, cause the display interface to display a congratulatory message.
